(19) United States
(12) Patent Application Publication
(10) Pub. No.: US 2004/0061474 A1
(43) Pub. Date: Apr. 1, 2004

(54) Fuel cell with battery, electronic apparatus having fuel cell with battery, and method of utilizing same

(75) Inventor: Akihiro Ozeki, Tokyo (JP)

Correspondence Address: FOLEY & LARDNER, 2029 CENTURY PARK EAST, SUITE 3500, LOS ANGELES, CA, 90067

(73) Assignee: KABUSHIKI KAISHA TOSHIBA

(21) Appl. No.: 10/427,583

(22) Filed: Apr. 30, 2003

(30) Foreign Application Priority Data
Sep. 30, 2002 (JP) JP2002-287892

(51) Int. Cl. H02J 7/00; H01M 16/00; H01M 10/48; H01M 10/46

(52) U.S. Cl. 320/101; 429/9; 429/90

(57) ABSTRACT

An electronic apparatus has a fuel cell, a battery, a circuit coupled to the fuel cell and the battery, for outputting electric power from at least one of the fuel cell and the battery, and an electronic device coupled to the circuit. The electronic device is operable with the electric power output from the circuit.

### CROSS-REFERENCE TO RELATED APPLICATIONS

This application is based upon and claims the benefit of priority from Japanese Patent Application No. 2002-287892, filed Sep. 30, 2002, the entire contents of which are incorporated herein by reference.

### BACKGROUND OF THE INVENTION

1. Field of the Invention

This invention relates to a fuel cell for generating electric power, and also an electronic apparatus, such as a portable computer, which incorporates the fuel cell.

2. Description of the Related Art

In recent years, various kinds of portable electronic devices which can be driven by batteries, such as a mobile information terminal called a PDA (personal digital assistant), a personal (mobile) computer, a digital camera or the like, have been developed and widely used.

Further, special attention has been focused on environmental problems lately and eco-friendly batteries have been actively developed. As a battery of this kind, a direct methanol type fuel cell (hereinafter, referred to as a DMFC: direct methanol fuel cell) has been known.

In the DMFC, methanol and oxygen, which are supplied as fuels, are subjected to a chemical reaction, and electric energy is obtained by the chemical reaction. It has a structure that two electrodes comprising porous metal or carbon sandwiching an electrolyte. See, “NENRYO DENCHI NO SUBETE” (“ALL ABOUT FUEL CELLS”), Hironosuke IKEDA, Kabushiki-Kaisha Nihon Jitsugyo Shuppansha, Aug. 20, 2001, pp. 216-217 incorporated herein by reference. Since the DMFC does not produce harmful waste, its practical use has been strongly demanded.

Now, in the DMFC, when an amount of output power is to be increased, it is necessary to increase a volume of a stack portion of the DMFC for causing a chemical reaction in proportion to the increase of the amount of output power. For this reason, in case that the DMFC should be applied to an electronic device, when its rated power is set to a value satisfying the maximum power of the electronic device, the size of the DMFC becomes considerably large. Particularly, regarding the mobile information terminal, the size of the product is an important factor, because the commercial value of the terminal is influenced by its portability.

Further, it is rare to require the maximum power of an electronic device during an ordinary use thereof.

### BRIEF SUMMARY OF THE INVENTION

Embodiments of the present invention provide an electronic apparatus accompanying a fuel cell unit and a secondary battery, which supplies with electric power.

According to an embodiment of the present invention, an electronic apparatus includes a fuel cell, a battery, a circuit coupled to the fuel cell and the battery, for outputting electric power from at least one of the fuel cell and the battery, and an electronic device coupled to the circuit. The electronic device is operable with the electric power output from the circuit.

Additional features and advantages of embodiments of the present invention will be set forth in the description which follows, and in part will be obvious from the description, or may be learned by practice of the invention. The features and advantages of embodiments of the present invention may be realized and obtained by means of the instrumentalities and combinations particularly pointed out hereinafter.

### BRIEF DESCRIPTION OF THE SEVERAL VIEWS OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view showing a portable personal computer according to an embodiment of the present invention;

FIG. 2 is a block diagram showing a hardware configuration of a fuel cell unit in the portable personal computer according to the embodiment;

FIG. 3 is a showing a relationship between rated power of the fuel cell unit and the maximum power demand of the portable personal computer, according to the embodiment;

FIG. 4 is a table showing operations of a DMFC cell stack and a secondary battery in the case that the power demand leaves extra power to the rated power of the DMFC cell stack, according to the embodiment;

FIG. 5 is a table showing operations of the DMFC cell stack and the secondary battery in the case that the power demand is within the rated power of the DMFC cell stack but there is not extra power thereto, according to the embodiment;

FIG. 6 is a table showing operations of the DMFC cell stack and the secondary battery in the case that the power demand is equal to or more than the rated power of the DMFC cell stack, according to the embodiment;

FIG. 7 is a table showing operations of the DMFC cell stack and the secondary battery in the case that the fuel run out and that the power demand is less than the rated power of the secondary battery, according to the embodiment;

FIG. 8 is a table showing operations of the DMFC cell stack and the secondary battery in the case that the fuel run out, and that the power demand is more than the rated power of the secondary battery, according to the embodiment;

FIG. 9 is a diagram showing characteristics of the DMFC cell stack according to the embodiment; and

FIG. 10 is a diagram showing an indicator and operation buttons provided on the fuel cell unit according to the embodiment.

### DETAILED DESCRIPTION

Preferred embodiments according to the present invention will be described hereinafter with reference to the accompanying drawings.

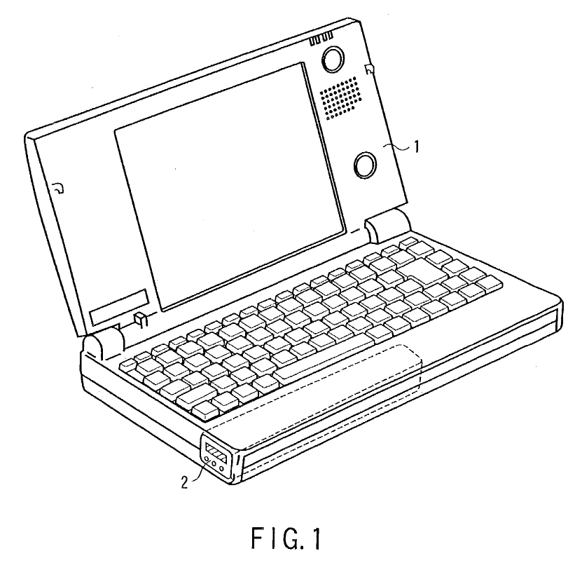

As shown in FIG. 1, a portable personal computer 1 as an electronic apparatus has a fuel cell unit 2 accommodated in the interior of its main body. Electronic devices in the personal computer 1 receives power supplied from the fuel cell unit 2 to operate, and attaching/detaching of the fuel cell unit 2 may be conducted simply in a sliding manner through an accommodating opening provided in a side face of the personal computer 1. Further, one side face of the fuel cell unit 2 is exposed from the accommodating opening of the personal computer 1 during accommodation of the unit in the personal computer 1, and an indicator and operation buttons described later are provided on the side face. The personal computer 1 also includes peripheral devices (not shown), such as a DVD-ROM drive, and a PC card connector and a USB connector for expanding the own function.

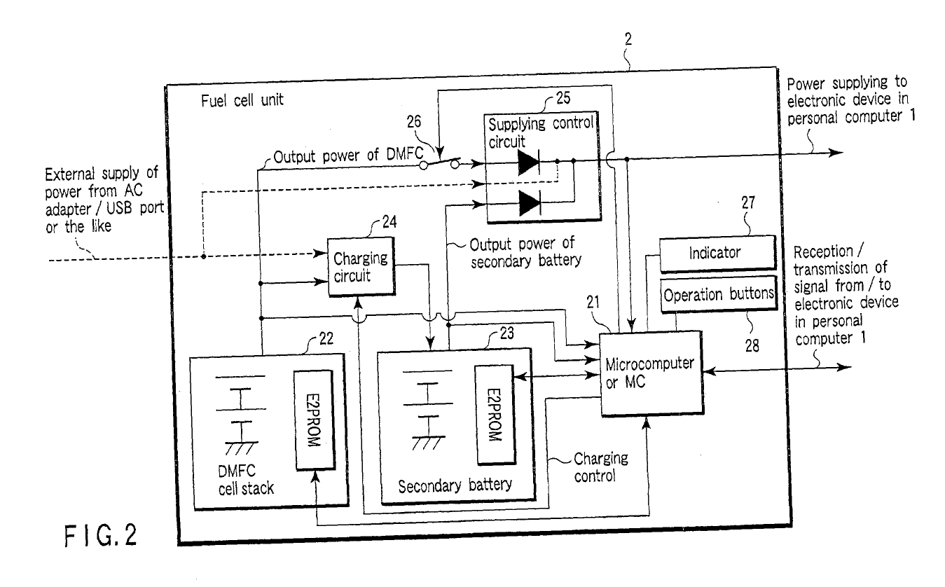

As shown in FIG. 2, the fuel cell unit 2 has a microcomputer 21, a DMFC cell stack 22, an EEPROM 22a, a secondary battery 23, an EEPROM 23a, a charging circuit 24, a supplying control circuit 25, a switch circuit 26, an indicator 27 and operation buttons 28.

The microcomputer 21 controls operation of the entire fuel cell unit 2, and performs execution of power supply using at least one of the DMFC cell stack 22 and the secondary battery 23 on the basis of a reception signal from a CPU (not shown) in the personal computer 1, and output voltage of each the DMFC cell stack and the secondary battery. For this purpose, the microcomputer 21 monitors the output voltage of both the DMFC cell stack and the secondary battery.

The DMFC cell stack 22 reacts methanol fed from a fuel tank (not shown) and air (oxygen) with each other to output electric power generated according to the chemical reaction. A detector (not shown) is arranged near the fuel tank, and outputs an empty signal to the microcomputer 21 when the fuel runs out. On the other hand, the secondary battery 23 is charged by electric power supplied from the DMFC cell stack 22 or externally, and outputs electric power. The charging circuit 24 performs charging of the secondary battery 23, in accordance with a command from the microcomputer 21.

The secondary battery may take the form of a capacitor or a conventional rechargeable battery (e.g. nickel cadmium, or metal halide).

The EEPROM 22a stores data indicative of rated power of the DMFC cell stack 22, and the EEPROM 23a stores indicative of rated power of the secondary battery 23.

The supplying control circuit 25 outputs electric power of at least one of the DMFC cell stack 22 and the secondary battery 23 externally according to the situation. The switch circuit 26 is for disconnecting output power of the DMFC cell stack 22 according to an instruction from the microcomputer 21. The indicator 27 displays the condition of the fuel cell unit 2, and the operation buttons 28 are for specifying contents of the display of this indicator 27.

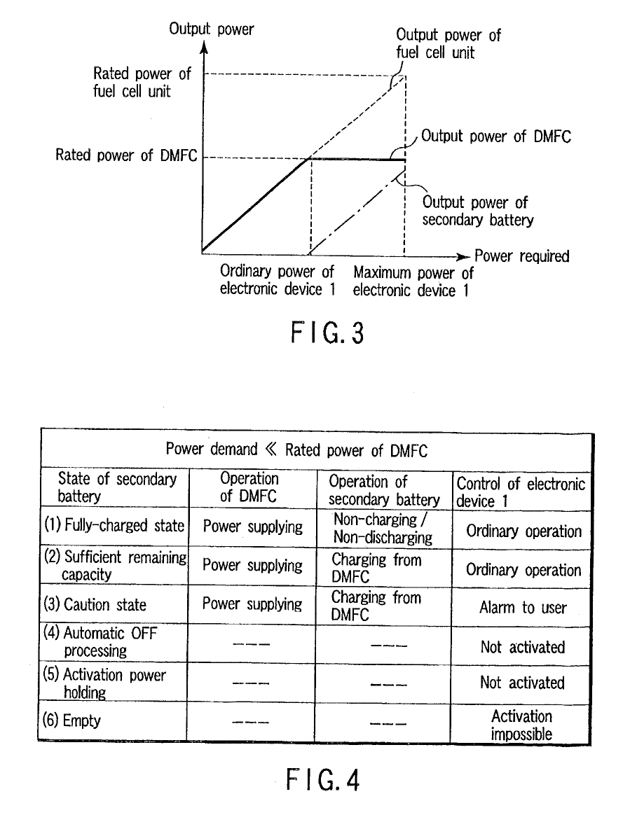

The rated power defined in the fuel cell unit 2 will be described with FIG. 3.

The amount of power supply of the fuel cell unit 2 may meet the power demand of the personal computer 1. However, since the amount of the electric power generated in the DMFC cell stack 22 is proportional to the volume of the DMFC cell stack 22, if the DMFC cell stack 22 is designed so as to meet the maximum power of the personal computer 1, the size thereof becomes great. Further, it is rare to operate the personal computer 1 with the maximum power under a normal operating condition. The maximum power is required as an instantaneous peak power in many cases. That is, when the maximum power of the personal computer 1 is set as the rated power, the DMFC cell stack 22 seldom reaches its capable performance in ordinary use, which may result in useless volume and weight.

In view of the above, in the fuel cell unit 2, the rated power of the DMFC cell stack 22 is not set to the maximum power demand in case that the peripheral device or an extension device is used for the personal computer 1 but to the power required during ordinary use of the personal computer 1, so that the DMFC cell stack 22 is not required to be large. Then, power exceeding the rated power of the DMFC cell stack 22 is supplied from the secondary battery 23 used together with the DMFC cell stack 22. Further, the secondary battery 23 may be small such that the capacity thereof only supplements shortage of the DMFC, so that the result is to reduce the total size of the fuel cell unit 2.

That is, in the fuel cell unit 2, the DMFC cell stack 22 and the secondary battery 23 are configured to meet the following relationship.

Rated power of the fuel cell unit 2 --- (X(W))=Rated power of the DMFC cell stack 22+Rated power of the secondary battery 23

X(W)>Rated power of the DMFC cell stack 22 --- (Y(W))=power which the personal computer 1 uses in an ordinary situation (power except for power used in an extension (such as a CD or DVD player, external monitor, etc.))

(Y(W))>Rated power of the secondary battery 23 --- (Z(W))

>=Rated power (i.e., maximum power) of the personal computer 1—Rated power of the DMFC cell stack 22

In this embodiment, X(W), Y(W), and Z(W) are 60W, 35W, and 25W, respectively.

Next, operations of the DMFC cell stack 22 and the secondary battery 23 in respective states will be explained with reference to FIGS. 4 to 8.

Incidentally, the battery power of the secondary battery 23 will be classified in the following manner.

(1) Fully-charged state (90-100%): The secondary battery 23 supplements power when the power demand is more than the electric power generated by the DMFC cell stack 22.

(2) Sufficient remaining capacity state (30-90%): The secondary battery 23 supplies power when the power demand is more than the electric power generated by the DMFC cell stack 22. When the power demand is less than the electric power generated by the DMFC cell stack 22, contrarily, the secondary battery 23 is charged by the charging circuit 24.

(3) Caution state (20-30%): The secondary battery 23 supplies electric power when the power demand is more than the electric power generated by the DMFC cell stack 22. In the meantime, the microcomputer 21 transmits a caution signal to the personal computer 1, and the personal computer 1 displays a massage informing a user that the battery power of the secondary battery 23 is low. The user is thus cautioned that the secondary battery 23 may only operate for a short time if the power demand is more than the rated power of the DMFC cell stack 22. When the power demand is less than the electric power generated by the DMFC cell stack 22, contrarily, the secondary battery 23 is charged by the charging circuit 24 as well as the state (2).

(4) Automatic OFF processing state (10-20%): The microcomputer 21 provides the personal computer 1 with a signal for commanding a shut down of the personal computer 1, so as not to lose data. This signal is useful because it may be soon difficult or impossible for the fuel cell unit 2 to supply the electric power in the case that personal computer power operation is needed which is equal to or more than the rated power of the DMFC cell stack 22.

(5) Actuating power holding state (2-10%): The Secondary battery 23 does not supply power to any devices connected externally to the personal computer 1, but it stores power required for the next activation of the DMFC cell stack 22 and maintains power to internal circuits within the personal computer 1.

(6) Empty (0-2%): It is fully-discharged state. When the secondary battery 22 falls into this state, the secondary battery 23 is not able to supply electric power any more, and needs to be charged by an external device.

The microcomputer 21 controls operations of the DMFC cell stack 22 and the secondary battery 23, as shown in FIGS. 4 to 8, according to respective states of the secondary battery 23.

As shown in FIG. 4, when the steady-state power demand of the personal computer 1 is lower than the rated power of the DMFC cell stack 22, the secondary battery 23 does not supply electric power. Therefore, the state of the secondary battery 23 is never changed to the automatic OFF state during operation of the personal computer 1. During the activation (power-up) of the personal computer 1 (not reflected in FIG. 4), the secondary battery 23 is used. When the secondary battery 23 is in the caution state (3) at the time of activation, then after activation, the secondary battery 23 is charged by the charging circuit 24. Meanwhile, an alarm is issued to the user until the battery power reaches a sufficient remaining capacity (2). This alarm may be provided to the user from the personal computer 1 according to a notification from the fuel cell unit 2 (the secondary battery 23a and the microcomputer 21). The alarm may be provided visually by displaying an alarm indicator on an LCD provided on the personal computer 1 or it may be provided by voice massage through a speaker provided in the personal computer 1 or the like.

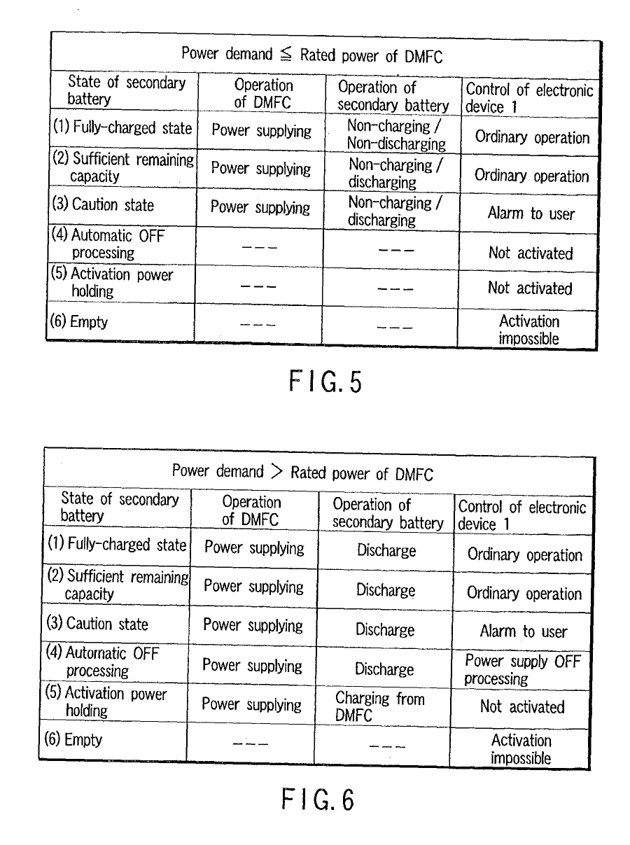

FIG. 5 shows operations of the DMFC cell stack 22 and the secondary battery 23 in the case that the power demand is within the rated power of the DMFC cell stack but there is not extra power thereto, namely a difference between the power demand and the power generated by the DMFC cell stack 22 is insufficient to charge the secondary battery.

In this case, because the secondary battery 23 does not provide electric power, the state of the secondary battery 23 is not changed to the automatic OFF state during operation of the personal computer 1 as well as the case shown in FIG. 4. In this case, charging of the secondary battery 23 by the DMFC cell stack 22 is not performed.

FIG. 6 shows operations of the DMFC cell stack 22 and the secondary battery 23 in the case that power demand of the personal computer 1 is equal to or more than the rated power of the DMFC cell stack 22.

The state of the secondary battery 23 changes in the extent between the full charged state (1) to the automatic OFF state (4) in this case. When the power OFF processing on the personal computer 1 has been completed in the automatic OFF state (4), charging of the secondary battery is started. Then, the secondary battery 23 does not discharge to the empty state during the operation of the personal computer 1.

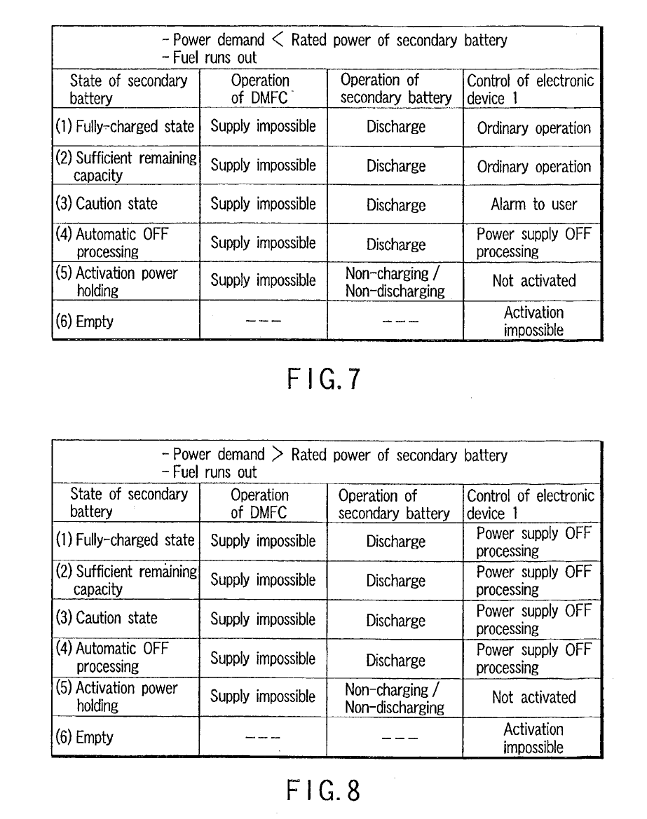

Furthermore, FIG. 7 and FIG. 8 shows operations of the DMFC cell stack 22 and the secondary battery 23 in the case that fuel runs out, then the DMFC cell stack 22 stops to generate the electric power.

In the case that the secondary battery 23 has sufficient rated power, it is possible to operate the personal computer 1 with only the secondary battery 23.

FIG. 7 shows a case that the personal computer 1 operates by only the secondary battery 23, when the power demand is less than the rated power of the secondary battery 23.

On the other hand, FIG. 8 shows a case that the personal computer 1 does not operate even though there is power in the secondary battery 23, because the power demand is more than the rated power of the secondary battery 23.

In the case that the personal computer 1 operates with only the secondary battery 23, the personal computer 1 may be activated when the secondary battery 23 is in either one of states (1), (2), or (3). On the other hand, in the case that the personal computer 1 does not operate with only the secondary battery 23 (i.e., the DMFC cell stack 22 is also needed), the power OFF processing is performed unconditionally whenever the DMFC cell stack 22 can not be used.

Incidentally, the number of stacks in the DMFC cell stack 22 is designed such that the minimum voltage of the stacks is equal to the voltage of the secondary battery 23. The supplying control circuit 25 controls power supply from the DMFC cell stack 22 and the secondary battery 23 by a diode OR circuit.

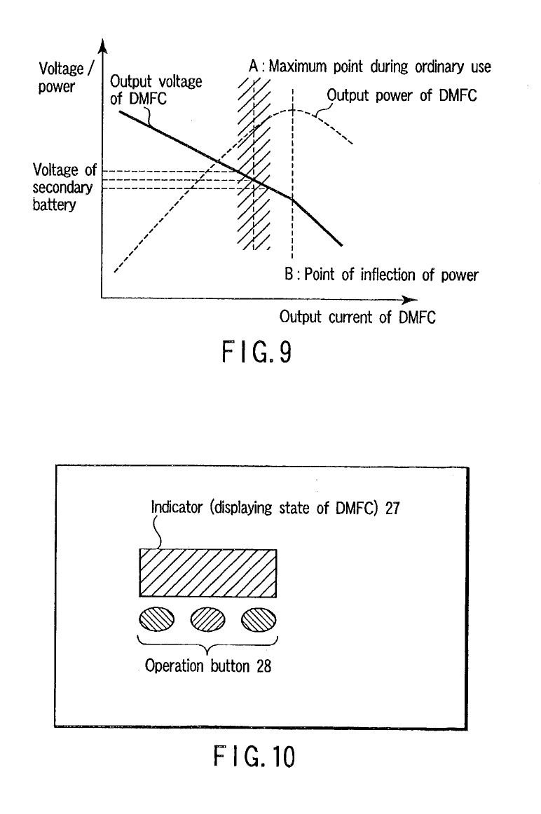

As shown in FIG. 9, the DMFC cell stack 22 has such a characteristic that the output voltage lowers according to increase of the output power. When the output power of the DMFC cell stack 22 exceeds point B on the graph, the DMFC cell stack 22 may not return to its normal operation state. Therefore, the microcomputer 21 controls the DMFC cell stack 22 such that the DMFC cell stack 22 is operated to the left side region from point B. Incidentally, point A on the graph is generally set as the maximum power/maximum voltage in view of individual differences between fuel cells. Data indicative of the voltage corresponding to each the point A and the point B are stored in the EEPROM 22a.

The DMFC cell stack 22 is constituted by connecting a plurality of cells in series and it is usually used as a high-voltage source. Therefore, the number of the stacks is set such that the voltage of the DMFC cell stack 22 at point A becomes equal to the voltage of the secondary battery 23. In this case, when the voltage of the DMFC cell stack 22 falls to point A, the supplying control circuit 25 starts power supply from the secondary battery 23 having the same potential as the DMFC cell stack 22. Thereby, the DMFC cell stack 22 makes the output voltage constant, and supplements the shortage of the electric power from the secondary battery 23.

Though a change of voltage according to the battery power occurs in the secondary battery 23, its voltage change width is smaller than that of the DMFC cell stack 22. That is the reason that the dotted region in the vicinity of point A becomes a region of the maximum power/maximum voltage of the DMFC cell stack 22.

As described above, when the output power of the DMFC cell stack 22 exceeds point B according to the voltage increase, it may not return to its ordinary state. For this reason, the microcomputer 21 monitors the voltage of the DMFC cell stack 22, and when the voltage reaches point B, the microcomputer 21 causes the switch circuit 26 to perform a temporary disconnection of the power supply line from the DMFC cell stack 22. The personal computer 1 is informed of the temporary disconnection of the power supply by the microcomputer 21. In response, the personal computer 1 assumes a low power consumption mode.

The microcomputer 21 makes the DMFC cell stack 22 restart supplying power at a time when the operation of the DMFC cell stack 22 returns to the normal region, and sends a signal informing the CPU in the personal computer 1 of the restart. The personal computer 1 then changes the low power consumption mode to a normal mode.

Next, when the DMFC cell stack 22 has fallen in an abnormal state for any reason, the microcomputer 21 causes the switch circuit 26 to disconnect the supply line. Under this condition, the microcomputer 21 informs the CPU in the personal computer 1 of disconnecting the supply line, while the secondary battery 23 supplies power sufficient to allow a safe shutdown of the personal computer 1. Further, power required for shutdown of the DMFC cell stack 22 is supplied to the inside of the fuel cell unit 2. Incidentally, information about point B is stored in the EEPROM 22a housed in the DMFC cell stack 22.

Now, as a means for notifying the state of the DMFC cell stack 22 to the user during power OFF of the personal computer 1, the fuel cell unit 2 has the above-described indicator 27 and the operation buttons 27. The microcomputer 21 displays the following items through the indicator 27.

(1) Current operating state: OFF, output of only the DMFC cell stack 22, output of only the secondary battery 23, joint use of the DMFC cell stack 22 and the secondary battery 23, and on/off state of charging of the secondary battery 23.

(2) Remaining volume of fuel.

(3) Battery power of the secondary battery.

Further, the microcomputer 21 switches display contents on the indicator 27 on the basis of operation of the operation buttons 28.

Thus, according to the fuel cell unit 2, proper joint use of the DMFC cell stack 22 and the secondary battery 23 may be conducted.

The present invention is not limited to the aforementioned embodiments.

The rated power of each the DMFC cell stack and the secondary battery may be changed to appropriate combinations, e.g. 40W and 20W, or 45W and 15W respectively.

Moreover, regarding the situations of the secondary battery 23, the DMFC cell stack 22 may supply the electric power to personal computer 1 so long as the power demand is less than the electric power generated by the DMFC cell stack 22 in Automatic OFF processing state (4), Actuating power holding state (5), or Empty state (6).

Furthermore, the secondary battery may be a primary battery in the case that electric power of the primary battery supplements the shortage of the electric power of the DMFC cell stack 22. The primary battery should be replaceable for a case that the previous one has run out.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. An electronic apparatus, comprising:
a fuel cell;
a battery;
a circuit coupled to said fuel cell and said battery, for outputting electric power from at least one of said fuel cell and said battery; and
an electronic device coupled to said circuit, the electronic device being operable with the electric power output from the circuit.

2. An electronic apparatus according to claim 1, wherein the circuit is operable for outputting the electric power such that the electric power of said battery supplements a shortage of electric power of said fuel cell.

3. An electronic apparatus according to claim 1, further comprising a switch coupled between said fuel cell and said circuit, for disconnecting the power supply from said fuel cell.

4. An electronic apparatus according to claim 3, further comprising a microcomputer coupled to the switch and the electronic device,
wherein said microcomputer controls said switch to disconnect the power supply, and provides said electronic device with a signal informing of the disconnection.

5. An electronic apparatus according to claim 1, wherein a rated power of said fuel cell is larger than that of said battery.

6. An electronic apparatus according to claim 1, wherein a rated power of said fuel cell is smaller than the maximum power demand of said electronic device.

7. An electronic apparatus according to claim 1, wherein a rated power of said fuel cell is approximately equal to electric power that said electronic device uses in a state of normal operation which exclude a power-up operation and an operation in which external devices are connected to said electronic device.

8. An electronic apparatus according to claim 1, further comprising a microcomputer coupled to said electronic device, for receiving power demand.

9. An electronic apparatus according to claim 8, wherein said microcomputer is operable for providing said electronic device with a signal assuming shut down operation of said electronic device under a condition that the battery power of said battery is less than a predetermined level.

10. An electronic apparatus according to claim 1, wherein said battery provides the electronic device with the electric power when the fuel supplied to the fuel cell runs out.

11. An electronic apparatus according to claim 1, wherein said battery is a primary battery.

12. An electronic apparatus according to claim 1, wherein said battery is a secondary battery.

13. An electronic apparatus according to claim 12, further comprising a charging circuit coupled to said fuel cell and said secondary battery.

14. An electronic apparatus according to claim 13, wherein the charging circuit is operable for charging said secondary battery, using the electric power from said fuel cell, when the power demand of said electronic device is less than the electric power generated by said fuel cell.

15. An electronic apparatus according to claim 14, wherein the charging circuit is operable for stopping charging said secondary battery, when a difference between the power generated by said fuel cell and the power demand is below a threshold.

16. A cell unit, comprising:
a fuel cell;
a battery; and
a circuit coupled to said fuel cell and said battery, for outputting electric power from at least one of said fuel cell and said battery.

17. A cell unit according to claim 16, wherein the electric power of said battery supplements the shortage of the electric power of said fuel cell.

18. A cell unit according to claim 16, wherein a rated power of said fuel cell is larger than that of said battery.

19. A cell unit according to claim 16, further comprising a switch coupled between said fuel cell and said circuit, and a microcomputer coupled to said switch,
wherein said switch disconnects the power supply from said fuel cell based on a signal output from said microcomputer.

20. A cell unit according to claim 19, wherein said microcomputer is operable for outputting the signal when the output voltage of said fuel cell is lower than a predetermined value.

21. A cell unit according to claim 20, further comprising a memory coupled to said microcomputer, for storing a data indicative of the predetermined value.

22. A cell unit according to claim 16, further comprising a display for displaying a status information of at least one of said fuel cell and said battery.

23. A cell unit according to claim 22, wherein the status information includes current operating state, remaining volume of fuel, and battery power of said battery.

24. A cell unit according to claim 23, further comprising a button for changing the displayed status information.

25. A cell unit according to claim 16, wherein said battery provides the electronic device with the electric power when the fuel supplied to the fuel cell runs out.

26. A cell unit according to claim 16, wherein said battery is a primary battery.

27. A cell unit according to claim 16, wherein said battery is a secondary battery.

28. A cell unit according to claim 27, further comprising a charging unit coupled to said fuel cell and said secondary battery, for charging said secondary battery with power supplied from said fuel cell.

29. A method for providing an electronic device with electric power from a fuel cell and a battery, comprising the steps of:
providing the electronic device with electric power from the fuel cell when a rated power of the fuel cell is more than a power demand of the electric power; and
providing the electric device with electric power from both the fuel cell and the battery when the power demand exceeds the rated power of the fuel cell.

30. A method according to claim 29, further comprising the step of stopping providing the electronic device with the power from the fuel cell when the output voltage of the fuel cell is less than a predetermined level.

31. A method according to claim 29, wherein the battery is a secondary battery.

32. A method according to claim 31, further comprising the step of charging the secondary battery with the electric power from the fuel cell when the power demand of the electronic device is less than the electric power generated by the fuel cell.
